(19) United States
(12) Patent Application Publication
(10) Pub. No.: US 2006/0136519 A1
(43) Pub. Date: Jun. 22, 2006

(54) System and method for user database synchronization

(76) Inventors: Anurag Batta, Hoffman Estate, IL (US); Mohan Kasibhatla, Mount Prospect, IL (US)

Correspondence Address: MOTOROLA, INC., 1303 EAST ALGONQUIN ROAD, IL01/3RD, SCHAUMBURG, IL, 60196, US

(21) Appl. No.: 11/015,447

(22) Filed: Dec. 17, 2004

(51) Int. Cl. G06F 17/30

(52) U.S. Cl. 707/204

(57) ABSTRACT

A first server (204) and second server (210) are mutually authenticated. Upon mutually authenticating the first (204) and second servers (210), the first server (204) responsively sends account information to the second server (210) and the second server (210) sends account information to the first server (204). Responsive to receiving the account information, a first database (202) associated with the first server (204) is synchronized to a second database (208) associated with second server (210) using the first and second server account information.

### FIELD OF THE INVENTION

The field of the invention relates to storing information in networks and, more specifically, to maintaining and managing this stored information.

### BACKGROUND OF THE INVENTION

In communication networks, servers and other devices communicate with each other and with other entities in the network. In addition, various databases are maintained within the networks to store information. The information stored at different databases frequently relates to the same user or user application. For instance, information relating to the same user account may be maintained at various databases in the network to facilitate the processing of bills for a user or accessing of the information by the user. Servers are often provided to both access and process the information.

Remote Authentication Dial-In User Service (RADIUS) servers are one type of server used in networks and typically provide accounting and authentication functions to users. RADIUS servers are often used by Internet Service Providers (ISPs) to provide these functions. In one example of the use of RADIUS servers, users supply authentication data to establish their identity to the RADIUS servers. The RADIUS servers check this data against data that is stored in databases on the network to determine if the user can utilize the system.

Sometimes the servers in the network may need to replicate or share user data located in multiple databases. For example, a mobile router application may need to access, obtain, and use information from two databases in order to authenticate mobile users in the network.

Unfortunately, problems have arisen in previous systems when servers need to use data relating to the same user but which is present in multiple databases. Because RADIUS servers are often manufactured and programmed by different vendors, different approaches are typically used to access and modify the information stored in the network databases. As a result of the differences in the servers and their underlying programming, information in some databases frequently becomes unsynchronized with respect to information stored in the other databases of the network. Consequently, the accuracy of this information becomes questionable and processing the information creates results that are frequently unreliable or inaccurate.

### BRIEF DESCRIPTION OF THE DRAWINGS

FIG. 1 is a flowchart of a method of synchronizing information in a network according to the present invention;

FIG. 2 is a block diagram of a system for synchronizing information in a network according to the present invention; and

FIG. 3 is a call flow diagram of an approach for synchronizing information in a network according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION OF THE PREFERRED EMBODIMENTS

A system for synchronizing databases in a network mutually authenticates servers and sends messages, for example, Attribute Value Pairs (AVPs), to synchronize the information in a plurality of databases. Since the databases are synchronized, processing operations can be undertaken without errors occurring due to the usage of unsynchronized information.

In many of these embodiments, first and second servers, which may be RADIUS servers, are mutually authenticated. Upon mutually authenticating the first and second servers, the first server responsively sends account information to the second server and the second server sends account information to the first server. Responsive to receiving the account information, a first database associated with the first server is synchronized to a second database associated with second server using the first and second server account information.

The first and second server account information exchanged between the first and second servers may be sent using Attribute Value Pairs (AVPs). In addition, the Extensible Authentication Protocol/Transport Layer Security (EAP TLS) protocol may be used to authenticate the first and second servers. Furthermore, synchronizing the databases may include updating and changing selected contents of the first and second data bases.

Thus, servers can share or exchange information from different databases even though the servers are manufactured and/or programmed by different vendors and may rely on different and incompatible underlying different management systems. The approaches described herein provide for synchronized databases that can be used by different applications. Unreliable results or other errors from processing this information is significantly reduced or eliminated due to the synchronization of the databases.

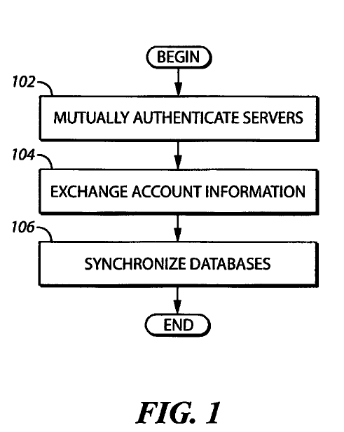

Referring now to FIG. 1, one example of an approach to synchronize databases in a network is described. At step 102, the servers mutually authenticate each other. The servers may be Remote Authentication Dial-In User Service (RADIUS) servers. The servers may exchange information with each other using the Extensible Authentication Protocol/Transport Layer Security (EAP TLS) protocol or by using any other standard security protocol. In the case of using the EAP TLS protocol, information is preferably sent in an encrypted format between the servers. This encrypted information may relate to end users, who are authenticated by RADIUS servers. For example, the information may indicate the types of information a user is authorized to access. One example of authentication information is a user name and password. Other protocols and types of authentication information may also be used in performing authentication functions between the servers.

At step 104, account information may be exchanged between the servers. For example, the user account data is transmitted from each of the servers to the other server. Attribute Value Pairs (AVPs) may be used to exchange the information. AVPs are typically defined as a pair of byte arrays, where the first value indicates the attribute and second determines the value of the attribute. Other mechanisms and message formats/protocols may also be used.

At step 106, the appropriate databases are synchronized. In this step, the information supplied at step 104 is applied to synchronize, modify, and/or update the corresponding or associated databases. Each server may authenticate one or more databases that is managed, updated, and/or accessed by the server. Further, each server can mutually authenticate other servers. In addition, one of the servers may act as a master and the other servers may act as clients. In this case, the client servers can request that the master server perform an update or, in an alternate approach, the client servers can initiate updates when there has been a change in databases associated with the master server.

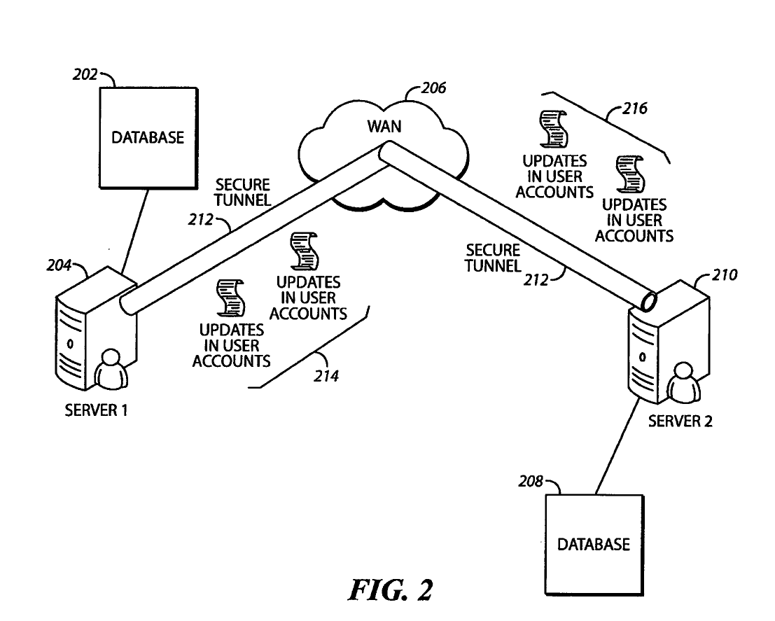

Referring now to FIG. 2, one example of a system for synchronizing databases in a network is described. The system includes first and second RADIUS databases 202 and 208, and first and second RADIUS servers 204 and 210. Each server typically includes the well-known communication elements of a transmitter having an output and a receiver having an input and also includes a controller coupled to the transmitter and receiver that may be programmed to operate in accordance with the present invention. These server and database components are coupled together and accessible using a Wide Area Network (WAN) 206. Alternatively, the WAN 206 may be a local area network, an intranet, an extranet such as the Internet, or some combination of these networks. Other examples of networks or combinations of networks may also be used to allow the components of the system to communicate with each other.

The servers 204 and 210 may be authentication and accounting servers that operate according to the RADIUS protocol. The databases 202 and 208 may include database access systems that are customized to the type of database and/or vendor specific. The databases 202 and 208 may store information in any format, for instance, in the flat file format. In this example, flat files are human-readable files including user account information and presented using alphanumeric characters. User equipment, for example, personal computers, may interface to the servers 204 and 210 or WAN 206.

In one example of the operation of the system of FIG. 2, the servers 204 and 210 first attempt to mutually authenticate each other. The servers 204 and 210 may authenticate each other using the Extensible Authentication Protocol/ Transport Layer Security (EAP TLS) protocol or some other suitable protocol. In this case, authentication information is exchanged with each of the servers 204 and 210 using the WAN 206 by establishing a secure tunnel 212 between a first server 204 and a second sever 210 via the WAN 206. This authentication information allows the first server 204 to authenticate the second server 210 and the second server 210 to authenticate the first server 204. This mutual authentication may be accomplished, in a preferred approach, by having the servers 204 and 210 exchange and confirm passwords or other security-related information.

Account update information 214 and 216 is then exchanged between the servers 204 and 210 after authentication is complete. The account update information can also be exchanged between the databases 202 and 208 via the secure tunnel 212. The account update information may be transported by ATPs or other suitable mechanism.

After the account update information 214 and 216 has been exchanged, the databases 202 and 208 are synchronized. Once the databases 202 and 208 are synchronized, they can securely exchange data, which includes user account information. Although only one database is shown relating to each of the servers 204 and 210, it will be understood that more databases may be updated and they may be used by other servers.

At this point, the information relating to a user account has been synchronized in the databases 202 and 208. A user or process operating anywhere on the network 206 or the servers 204 and 210 can access both of the databases 202 and 208, which have the updated and/or synchronized information.

In addition, one of the servers 204 or 210 may act as a master and the other server or servers may act as clients. For example, the server 204 may be the master server while another server 210 may be the client server. In this case, the client server 210 can request that the master server 204 make an update or the client servers 210 can initiate updates when there has been a change in database 202 associated with the master server 204.

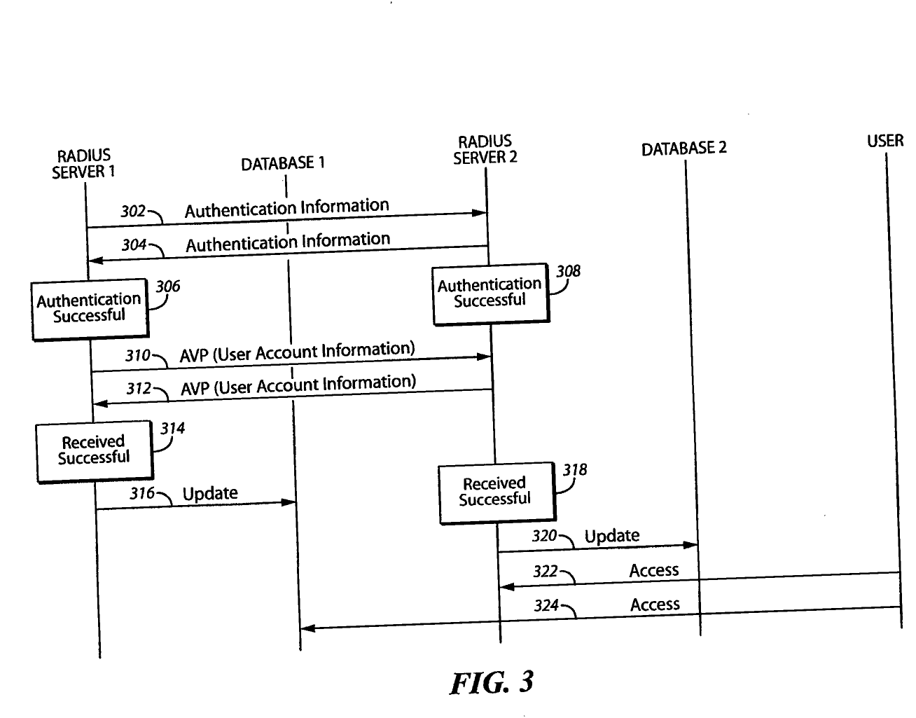

Referring now to FIG. 3, one example of a call flow diagram showing an approach for synchronizing databases in a network is described. At step 302, authentication information is sent from a first RADIUS server to a second RADIUS server. At step 304, authentication information is sent from the second RADIUS server to a first RADIUS server. In both cases, the information can be encrypted according to a predetermined protocol such as the Extensible Authentication Protocol/Transport Layer Security (EAP TLS) protocol. The authentication information can include password or other security-related information that allows the first server to authenticate the second server and the second server to authenticate the first server. To facilitate the secure transfer of information between the two servers, the information from the first and second servers may be exchanged via a secure information tunnel (the latter being generally well understood in the art).

At step 306, authentication is completed at the first server. At step 308, authentication is completed at the second server. At step 310, an Attribute Value Pair (AVP) message or other messaging mechanism recognizable by both servers is sent from the first server to the second server. At step 312, an AVP message is sent from the second server to the first server. The messages include account update information that may be used to update, change, modify, and/or synchronize information in the first and second databases.

At step 314, the first server successfully receives and processes the AVP message from the second server. At step 316, the first server updates the first database. At step 318, the second server successfully receives and processes the AVP message sent from the first server. At step 320, the second server updates the second database using the information in the AVP message received from the first server.

At steps 322 and 324, a user or process requires and performs the accessing of information from both the first database and the second database. The process may be an application that needs to access both databases, for instance, a billing process. Since the databases have been successfully updated and/or synchronized, the application can proceed to use and process the updated information from both of the databases. The information processed provides accurate results since the update has successfully been made in all relevant databases.

Thus, RADIUS or other types of servers can share or exchange information from different databases even though the servers are manufactured and/or programmed by different vendors and may rely on different and incompatible underlying management systems. Existing mechanisms such as AVP pairs can be used to accomplish these results. The approaches described herein allow synchronized databases that can be used by different applications with unreliable results or other errors significantly reduced or eliminated due to the synchronization of the information.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method for synchronizing databases in a network comprising:
mutually authenticating first and second servers;
upon mutually authenticating the first and second servers, responsively sending first server account information from the first server to the second server and second server account information from the second server to the first server; and
responsively synchronizing a first database associated with the first server to a second database associated with the second server using the first and second server account information.

2. The method of claim 1 wherein sending the first and second server account information comprises sending Attribute Value Pairs (AVPs) between the first and second servers.

3. The method of claim 1 wherein mutually authenticating the first and second servers comprises authenticating first and second RADIUS servers.

4. The method of claim 1 wherein mutually authenticating first and second servers comprises authenticating using Extensible Authentication Protocol/Transport Layer Security (EAP TLS) protocol.

5. The method of claim 1 wherein synchronizing comprises updating and changing selected data from the first and second databases.

6. A method for synchronizing databases associated with an originating server comprising:
sending a first authentication message to a second server;
receiving a second authentication message from the second server;
sending a first attribute value pair to the second server;
receiving a second attribute value pair message from the second server; and
responsively synchronizing a first database with a second database using the second attribute value pair message.

7. The method of claim 6 wherein synchronizing a first database comprises synchronizing a database in a flat file format.

8. The method of claim 6 wherein sending a first authentication message to a second server comprises sending a first authentication message to a RADIUS server.

9. The method of claim 6 further comprising authenticating the second server using the second authentication message.

10. The method of claim 6 further comprising authenticating the second server using the second authentication message according to Extensible Authentication Protocol/ Transport Layer Security (EAP TLS) protocol.

11. An originating server comprising:
a transmitter having an output;
a receiver having an input;
a controller coupled to the transmitter and the receiver, the controller programmed to send a first authentication message to a second server on the transmitter output and receive a second authentication message from the second server on the receiver input, the controller further programmed to send a first attribute value pair to the second server on the transmitter output and receive a second attribute value pair message from the second server on the receiver input.

12. The server of claim 11 wherein the controller comprises means to authenticate the second server.

13. The server of claim 12 wherein the controller further comprises means to authenticate the second server using Extensible Authentication Protocol/Transport Layer Security (EAP TLS) protocol.

14. The server of claim 11 wherein the second server is a RADIUS server.
